(19) United States
(12) Patent Application Publication
(10) Pub. No.: US 2003/0102846 A1
(43) Pub. Date: Jun. 5, 2003

(54) Battery charger

(76) Inventor: Friedrich Zauner, Eschenbach (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/149,904

(22) PCT Filed: Dec. 12, 2000
(86) PCT No.: PCT/DE00/04433

(30) Foreign Application Priority Data
Dec. 17, 1999 (DE) 199 60 955.1

(51) Int. Cl. H02J 7/16; H02J 7/04

(52) U.S. Cl. 320/162

(57) ABSTRACT

A battery charger is proposed which has a capacitance input (C) for inputting the rated capacitance of the battery (12) to be charged. A charge detector (14) detects the charge quantity (Ah) introduced during the charging. A charge comparator (15) generates a shutoff signal (A), which terminates the charging operation if the charge quantity (Ah) agrees with the input capacitance.

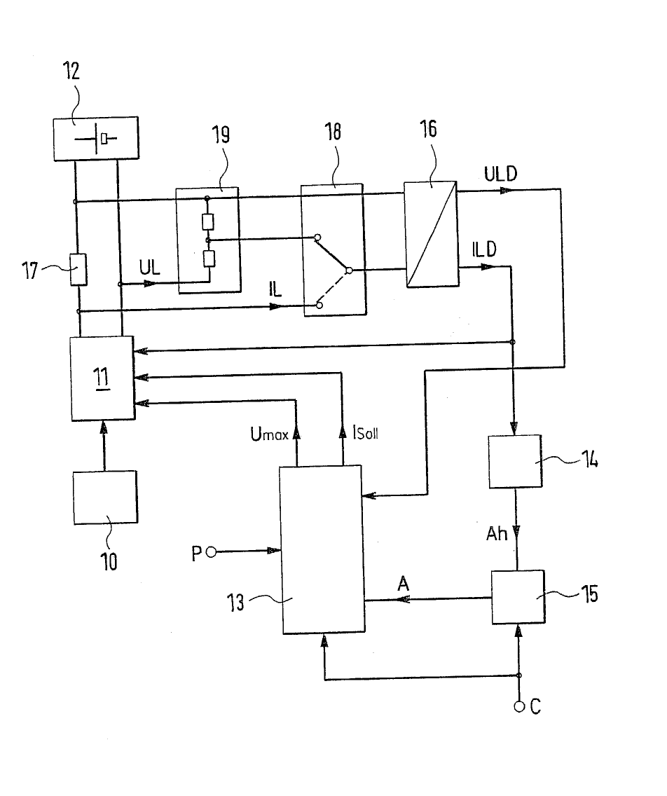

### PRIOR ART

The invention relates to a battery charger of the kind that has become known for instance from the professional journal entitled “ELVjournal”, No. 4/98, pages 81-83. The previously known battery charger has a keyboard for inputting various charging programs and for inputting battery data, such as the rated capacitance or rated voltage. From the input rated capacitance, the charging current is selected. The previously known charger is suitable not only for charging nickel-cadmium batteries but also for charging lead-acid batteries, which are charged by the constant-voltage method with current limitation. In this, the maximum allowable battery voltage is limited to a predetermined value, and the charging current is defined on the basis of the battery data that have been input. Until the maximum allowable charging voltage is reached, the charging current is regulated or controlled to the defined value. When the maximum allowable charging voltage is reached, conversely, the control or regulation is to the maximum allowable charging voltage, and the charging current decreases in the process.

It is the object of the invention to disclose a battery charger that largely avoids overcharging of the battery.

This object is attained by the characteristics recited in the independent claim.

### ADVANTAGES OF THE INVENTION

The battery charger of the invention has the advantage that the charging operation is terminated at the latest when the input charge is equivalent to the input rated capacitance of the battery to be charged. If the battery to be charged fails to meet the expected charging voltage during the charging operation, and if the charging voltage is used as a criterion for reducing the charging current, then proper termination of the charging operation would not be possible. In these cases, the battery charger of the invention terminates the charging operation even if a battery has one or more defective cells.

The maximum allowable charging voltage depends on a plurality of variables, such as the temperature and the prior history of the battery, so that the defined maximum allowable charging voltage can only be an estimated value. The battery charger of the invention makes it possible to define a comparatively high allowable maximum charging voltage, since in this case the charging operation is terminated after a charge quantity that corresponds to the rated capacitance is attained.

Advantageous features and refinements of the battery charger of the invention will become apparent from the dependent claims.

A first advantageous feature provides the definition of the charging current as a function of the input capacitance. This assures that the charging current will be adapted to the size of the battery. The allowable charging currents are indicated by the battery manufacturers and can be selected accordingly.

Another advantageous feature provides the definition of the charging current as a function of a predetermined charging program. With this provision, normal charging, accelerated charging or fast charging can for instance be specified by means of a suitable definition of the charging current. A combination of the charging program with the input rated capacitance is especially advantageous so as to remain within the allowable charging currents at all times.

A refinement of the battery charger of the invention provides the specification of a maximum allowable charging voltage. With this provision, protection of the battery is achieved. In a lead or lead gel battery, specifying the maximum allowable charging voltage prevents gassing in the battery, or at least keeps it within harmless limits.

An especially advantageous refinement in terms of specifying the maximum allowable charging voltage provides that the maximum allowable charging voltage is defined as a function of the specified charging program. For a specified fast charge, the maximum allowable charging voltage can be raised, so that the higher charging current can be made to flow.

An advantageous refinement of the charger of the invention provides a detection device for detecting the charging voltage. If a limitation to a specified maximum allowable charging voltage is provided, then this limitation can be cancelled at least briefly, to enable measuring the charging voltage established for a predetermined charging current. A comparator compares the charging voltage with a specified limit voltage and generates a shutoff signal as needed that likewise terminates the charging operation.

Further advantageous refinements and features of the battery charger of the invention will become apparent from the further dependent claims and from the ensuing description.

### DRAWING

The drawing shows a block circuit diagram of a battery charger of the invention.

An energy source 10 is connected via a charge regulator 11 to a battery 12 to be charged. The charge regulator defines the charging current as a function of a set-point charging current value Isoll and defines the voltage as a function of a maximum allowable charging voltage Umax. The set-point charging current value Isoll and the maximum allowable charging voltage Umax are furnished by a charge controller 13. The charge controller 13 receives signals from a program specifier P and a capacitance specifier C. A charge detector 14, from a digital actual charging current value ILD, ascertains the charge quantity Ah stored in the battery 12 during the charging operation and outputs it to a charge comparator 15, which compares the charge quantity Ah with the rated capacitance of the battery 12 that is specified via the capacitance specifier C. The charge comparator 15 outputs a first shutoff signal A to the charge controller 13.

The charge controller 13 is also supplied with a digital actual charging voltage value ULD, which an A/D converter 16 furnishes along with the digital actual charging current value ILD. The digital actual charging current value ILD is furnished not only to the charge detector but also to the charge regulator 11. The A/D converter 16 ascertains both the digital actual charging voltage value ULD and the digital actual charging current value ILD from the (analog) actual charging voltage value UL and the (analog) actual charging current value IL, respectively.

The actual charging current value IL is detected as a voltage drop, which occurs at a shunt 17. The shunt 17 is connected to a demultiplexer 18, which carries either the actual charging current value IL or the actual charging voltage value UL to the A/D converter 16. The actual charging voltage value UL is reduced by a voltage divider 19 and is made available to the A/D converter via the demultiplexer 18.

The battery charger of the invention functions as follows:

First, via the capacitance specifier C, the rated capacitance of the battery 12 to be charged must be input. In the exemplary embodiment shown, it is assumed that the battery 12 is a lead-acid battery. One suitable charging method, which should be specified in the charge regulator 11, provides that the battery 12 is first charged at a predetermined current Isoll until the maximum allowable charging voltage Umax is attained; this is followed by a constant-voltage mode, in which the voltage should be specified and is either lower than or at most equal to the maximum allowable charging voltage Umax. Depending on the input rated capacitance of the battery 12, the charge controller 13 defines the set-point charging current value Isoll that the charge regulator 11 is meant to establish. If the rated voltage of the battery 12 is known, for instance being 12 volts, then the charge controller 13 also specifies the maximum allowable charging voltage Umax, adapted to the set-point charging current value Isoll. Because of the unavoidable line resistance and the greater voltage drop at the internal resistor of the battery 12, the defined maximum allowable charging voltage Umax can be higher for a higher set-point charging current value Isoll than for a lower set-point charging current value Isoll.

Advantageously, the program specifier P is provided, which enables a selection to be made from a charging program. Along with discharging or battery maintenance programs not described in further detail here, the charging time in particular can be varied. For instance, a charging program can be specified within the context of normal charging, accelerated charging, or fast charging. The charge controller 13 therefore additionally defines the set-point charging current value Isoll as a function of the program specifier P and varies the maximum allowable charging voltage Umax accordingly as needed.

The battery charger of the invention in particular contemplates the detection of the actual charging current value IL, which in the exemplary embodiment shown is detected in the form of a voltage drop at the shunt 17. For the sake of higher efficiency, care should be taken that the shunt 17 have only a low resistance, so that the voltage drop is likewise only slight. The voltage divider 19 reduces the actual charging voltage value UL in order to arrive at least approximately at the same order of magnitude as the voltage drop at the shunt 17. The essential advantage of this provision is that the A/D converter can be set to the same conversion range for both input variables. The demultiplexer 18 assures that in a predeterminable chronological succession, either the actual charging current value IL or the actual charging voltage value UL is applied to the A/D converter 16.

The A/D converter 16 makes the digital actual charging current value ILD available, which is carried on the one hand to the charge regulator 11 as an actual value for current regulation that may possibly be contemplated and on the other to the charge detector 14. The charge detector executes an integration over time, and as its output signal it furnishes a measure of the charge quantity Ah stored in the battery 12 during the charging operation. Because the actual charging current value ILD is available in digital form, the charge detector 14 can be embodied in a simple fashion by means of a counter.

The charge quantity Ah detected is compared in the charge comparator 15 with the rated capacitance of the battery 12 that is input by the capacitance specifier C. If the stored charge quantity Ah attains the rated capacitance, then the charge comparator 15 outputs the first shutoff signal A to the charge controller 13, which terminates the charging operation. This provision assures that the charging operation is terminated at the latest when a charge quantity Ah that corresponds to the input rated capacitance of the battery 12 is reached. The first shutoff signal A causes the termination of the charging operation, regardless of which set-point charging current value Isoll or which maximum allowable charging voltage Umax the charge controller 13 specifies to the charge regulator 11. For instance, for a battery 12 in which at least one cell voltage is below the usual value, the maximum allowable charging voltage would not be reached, and the consequence would be that the charging operation would be continued at the full charging current for an arbitrary length of time, with the consequence that intact cells of the battery 12 would be overloaded considerably.

The first shutoff signal A also terminates the charging operation in the case where the maximum allowable charging voltage Umax is reached and the charging current IL is consequently reduced to values that depend on the internal resistance of the battery circuit connected to the charge regulator 11. In this operating state, the set-point charging current value can no longer be maintained, since the current can no longer be impressed. The charging is continued until such time as the first shutoff signal A, at the reduced charging current IL, terminates the charging operation when a charge quantity Ah corresponding to the rated capacitance is attained.

In addition, it can be provided that the actual charging voltage value UL is monitored for plausibility, for instance. For that purpose, the charge controller 13 assesses the furnished digital actual charging voltage value ULD, for instance as a function of the charging time. For instance, if after a short time a voltage corresponding to the maximum allowable charging voltage Umax occurs, this is an indication either that the battery 12 has come to have high impedance or is already fully charged. The charge controller 13 can also raise the specified maximum allowable charging voltage Umax briefly to unattainable values for testing purposes, in order at a specified set-point charging current value Isoll to detect the actual charging voltage value UL established in that case at the battery 12 and compare it with a limit value. If the predetermined limit value is exceeded, a second shutoff signal occurs in the charge controller 13, and this shutoff signal likewise terminates the charging operation on the basis of the voltage criterion.

In further features of the battery charger of the invention, an indicator unit can be provided, for instance, in order to show the variables described.

The battery charger of the invention is especially well suited for charging lead-acid batteries. Charging other types of batteries, such as nickel-cadmium batteries, is possible with suitable adaptation of the variables, that is, the charging voltage and charging current, that are furnished by the charge controller 13. Optionally, along with the first shutoff signal A, a further shutoff signal should be provided, which is obtained on the basis of other signal assessments. For example, provision can be made for assessing the course over time of the charging voltage UL by detecting the first and/or higher derivations in accordance with time.

New claims:

1. A battery charger having a capacitance input (C) for inputting the rated capacitance of a battery (12) to be charged, having a charge detector (14) for detecting the charge quantity (Ah) introduced during the charging, and having a charge comparator (15), which compares the detected charge quantity (Ah) with the input capacitance and if they agree generates a first shutoff signal (A), which terminates the charging operation, and a comparator, which compares the actual charging voltage value (UL) with a predetermined limit voltage (Umax) and which generates a second shutoff signal that terminates the charging operation if the actual charging voltage value (UL) attains the limit value, characterized in that a charge controller (13) is provided, and the charge controller (13) monitors the actual charging voltage value (UL) for plausibility in that the charge controller (13) assesses the actual charging voltage value as a function of the charging time, so that if the actual charging voltage value already attains the limit voltage after a short time, a battery that has come to have high impedance can be detected and the charging operation can be terminated.

2. The battery charger of claim 1, characterized in that the charge controller (13) tests the actual charging voltage value in that the predetermined maximum allowable charging voltage is briefly raised to unattainable values, in order at a predetermined set-point charging current value to detect the actual charging voltage value (UL) established at the battery and compare it with a limit value, so that if the limit value is exceeded the charging operation can be terminated.

3. The battery charger of one of the foregoing claims, in which a set-point charging current value (Isoll) is defined as a function of the input capacitance.

4. The battery charger of one of the foregoing claims, in which the set-point charging current value (Isoll) is defined as a function of a predetermined charging program (P).

5. The battery charger of claim 4, in which the maximum allowable charging voltage (Umax) is dependent on the charging program (P).

6. The battery charger of one of the foregoing claims, in which the actual charging current value (IL) is detected as a voltage drop at a shunt (17).

7. The battery charger of one of the foregoing claims, characterized in that the actual charging voltage value (UL) and the actual charging current value (IL) are applied via a demultiplexer (18) to a single input of an A/D converter (16) in chronological succession.

8. The battery charger of one of the foregoing claims, in which the actual charging voltage value (UL) is reduced by a voltage divider (19) prior to the A/D conversion.

9. A method for charging a battery, in which the charge quantity (Ah) introduced during the charging is detected and compared with the rated capacitance of the battery to be charged, and if they agree the charging operation is terminated, and the actual charging voltage value (UL) is compared with a predetermined limit voltage (Umax), and the charging operation is terminated if the actual charging voltage value (UL) exceeds the limit value (Umax), characterized in that the actual charging voltage value (UL) is monitored for plausibility, in that the actual charging voltage value is assessed as a function of the charging time, so that if the actual charging voltage value already attains the limit voltage after a short time, a battery that has come to have high impedance can be detected and the charging operation can be terminated.
